(19) United States
(12) Patent Application Publication
(10) Pub. No.: US 2004/0211318 A1
(43) Pub. Date: Oct. 28, 2004

(54) Motor fan design for large debris ingestion

(75) Inventors: Charles Jeff Morgan, Long Beach, MS (US); Owen T. Bourgeois, Pass Christian, MS (US); Dov Z. Glucksman, Wenham, MA (US)

Correspondence Address: DUFT SETTER OLLILA & BORNSEN LLC, 2060 BROADWAY, SUITE 300, BOULDER, CO, 80302, US

(73) Assignee: Oreck Holdings, LLC

(21) Appl. No.: 10/420,242

(22) Filed: Apr. 22, 2003

(51) Int. Cl. B01D 45/12

(52) U.S. Cl. 95/270; 55/406; 15/353

(57) ABSTRACT

An apparatus and method for moving a flow of air and particulates through a vacuum cleaner having a central hub with a hub axis and a plurality of vanes depending from the hub and extending in an approximately radial direction away from the hub axis, the vanes comprising an inner edge located near the central hub, an outer edge spaced radially outward from the inner edge, a first top edge, a second top edge located between the inner edge and the first top edge, and wherein the second top edge is orientated in a direction less than parallel to the hub axis.

### TECHNICAL FIELD

The present invention relates to methods and apparatuses for transporting a flow of air and particulates through a vacuum cleaner.

### BACKGROUND OF THE INVENTION

Conventional upright vacuum cleaners are commonly used in both residential and commercial settings to remove dust, debris and other particulates from floor surfaces, such as carpeting, wood flooring, and linoleum. A typical conventional upright vacuum cleaner includes a wheel-mounted head which includes an intake nozzle positioned close to the floor, a handle that extends upwardly from the head so the user can move the vacuum cleaner along the floor while remaining in a standing or walking position, and a blower or fan. The blower takes in a flow of air and debris through the intake nozzle and directs the flow into a filter bag or receptacle which traps the debris while allowing the air to pass out of the vacuum cleaner.

A typical blower assembly is comprised of a motor and a multi-bladed centrifugal fan housed in a multi-piece scroll assembly. An armature shaft protrudes from the motor through the center of the fan assembly and attaches to a nut.

One drawback with some conventional blowers is the design of the fan. For example, one conventional type of blower includes fan blades with a leading edge 90 degrees to the direction of flow. As debris enters the blower, larger debris can become lodges on the leading edge of the blade. Accordingly, the blower may become clogged resulting in a deceleration of the flow or complete stoppage of the blower.

Another drawback with conventional blowers is the gap between the leading edge of the fan blade and the scroll housing. With the leading edge of a fan blade at 90 degrees the gap between the leading edge and the scroll housing is small. As large debris enters the blower it can become lodged in the gap causing the fan to be jammed or fan blades to be sheared off.

Still another drawback with conventional blowers is the location of the nut that attaches the fan assembly to the motor. Conventional blowers locate the nut above the surface of the fan. As debris is ingested into the blower items such as candy wrappers and the like can become lodged on the nut thereby decreasing the efficiency of the blower. In addition, as the flow of air moves through the blower the location of the nut causes increased turbulence reducing the blower performance.

### SUMMARY OF THE INVENTION

The invention relates to methods and apparatuses for transporting a flow of air and particulates through a vacuum cleaner. In one embodiment, the apparatus includes an improved blower assembly for ingesting the flow of air and particulates. The blower assembly can further include a fan assembly where the fan blade has a leading edge angled less than ninety degrees and increased inlet geometry. In addition, the fan assembly is attached to the motor armature through a nut recessed into the fan.

### BRIEF DESCRIPTION OF THE DRAWINGS

FIG. 1 is a front isometric view of a vacuum cleaner in accordance with an embodiment of the invention.

FIG. 2 is an exploded isometric view of the intake body shown in FIG. 1.

FIG. 3. is an exploded isometric view of the airflow propulsion device shown in FIG. 2.

FIG. 4 is a front view of the fan shown in FIG. 3.

FIG. 5. is a side view of the fan shown in FIGS. 3 & 4.

### DETAILED DESCRIPTION OF THE INVENTION

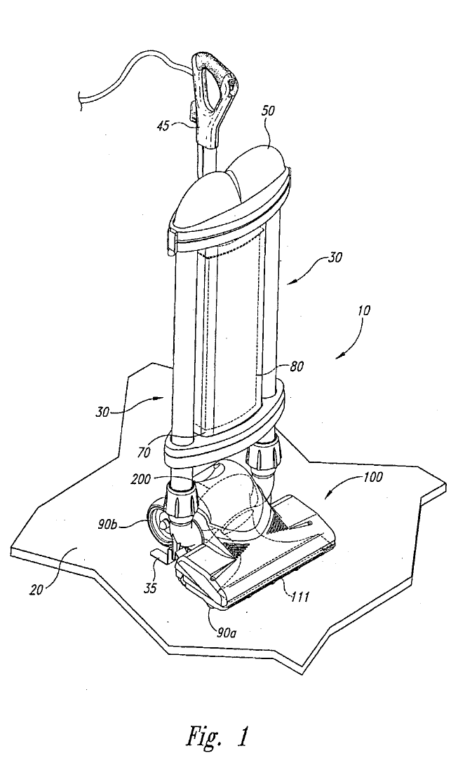

The present invention is directed toward methods and apparatuses for moving a flow of air and particulates into a vacuum cleaner. The apparatus includes an improved blower assembly for ingesting the flow of air and particulates. Many specific details of certain embodiments of the invention are set forth in the following description and in FIGS. 1-5 to provide a thorough understanding of such embodiments. One skilled in the art, however, will understand that the present invention may have additional embodiments and that they may be practiced without several of the details described in the following description.

FIG. 1 is an isometric view of a vacuum cleaner 10 in accordance with an embodiment of the invention positioned to remove particulates from a floor surface 20. The vacuum cleaner 10 can include a head or intake body 100 having an intake nozzle including an intake aperture 111 for receiving a flow of air and particulates from the floor surface 20. An airflow propulsion device 200 draws the flow of air and particulates through the intake opening 111 and directs the flow through two conduits 30. The conduits 30 conduct the flow to a manifold 50 that directs the flow into a filter element 80. The air passes through porous walls of the filter element 80 and through a porous filter housing 70, leaving the particulates in the filter element 80. The vacuum cleaner 10 further includes an upwardly extending handle 45 and wheels 90 (shown as forward wheels 90a and rear wheels 90b) for controlling and moving the vacuum cleaner over the floor surface 20.

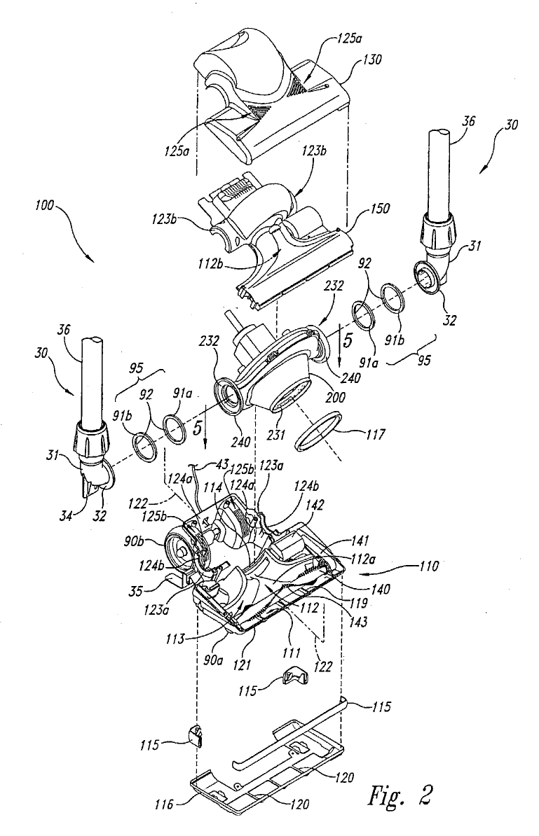

FIG. 2 is an exploded isometric view of an embodiment of the intake body 100 shown in FIG. 1. The intake body 100 includes a baseplate 110 and an inner cover 150 that are joined together around the airflow propulsion device 200. An outer cover 130 attaches to the inner cover 150 from above to shroud and protect the inner cover 150 and the airflow propulsion device 200. A skid plate 116 is attached to the lower surface of the baseplate 110 to protect the baseplate 110 from abrasive contact with the floor surface 20 (FIG. 1). Bumpers 115 are attached to the outer corners of the baseplate 110 to cushion inadvertent collisions between the intake body 100 and the walls around which the vacuum cleaner 10 (FIG. 1) is typically operated.

As shown in FIG. 2, the forward wheels 90a and the rear wheels 90b are positioned to at least partially elevate the baseplate 110 above the floor surface 20 (FIG. 1). The outer cover 130 can include intake vents 125a for ingesting cooling air to cool the airflow propulsion device 200. The baseplate 110 can include exhaust vents 125b for exhausting the cooling air. Accordingly, cooling air can be drawn into the intake body 100 through the intake vents 125a (for example, with a cooling fan coupled to the airflow propulsion device 100), past the propulsion device 200 and out through the exhaust vents 125b.

The intake aperture 111 has an elongated rectangular shape and extends across the forward portion of the baseplate 110. A plurality of ribs 119 extend across the narrow dimension of the intake aperture 111 to structurally reinforce a leading edge 121 of the baseplate 110. The skid plate 116 can also include ribs 120 that are aligned with the ribs 119. Accordingly, the flow of air and particulates can be drawn up through the skid plate 116 and into the intake aperture 111.

An agitation device, such as a roller brush 140, is positioned just above the intake aperture 111 to aid in moving dust, debris, and other particulates from the floor surface 20 and into the intake aperture 111. Accordingly, the roller brush 140 can include an arrangement of bristles 143 that sweep the particulates into the intake aperture 111. The roller brush 140 can be driven by a brush motor 142 via a flexible belt 141 or other mechanism.

The intake body 100 further includes a flow channel 112 positioned downstream of the intake aperture 111 and the roller brush 140. The flow channel 112 includes a lower portion 112a positioned in the baseplate 110 and a corresponding upper portion 112b positioned in the inner cover 150. When the inner cover 150 joins with the baseplate 110, the upper and lower portions 112b and 112a join to form a smooth enclosed channel having a channel entrance 113 proximate to the intake aperture 111 and the roller brush 140, and a channel exit 114 downstream of the channel entrance 113.

As shown in FIG. 2, the channel entrance 113 has a generally rectangular shape with a width of the entrance 113 being substantially greater than a height of the entrance 113. The channel exit 114 has a generally circular shape to mate with an entrance aperture 231 of the airflow propulsion device 200. The channel exit 114 is sealably connected to the airflow propulsion device 200 with a gasket 117 to prevent flow external to the flow channel 112 from leaking into the airflow propulsion device and reducing the efficiency of the device.

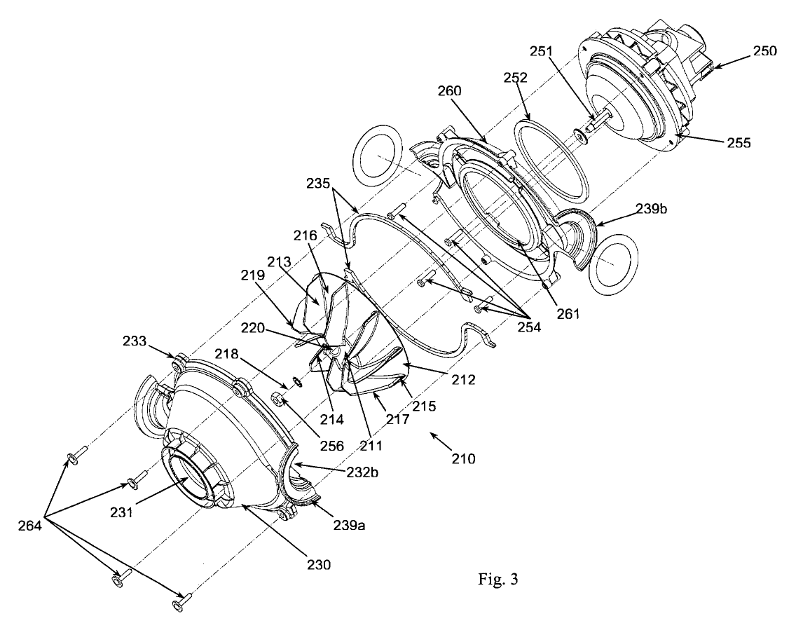

FIG. 3 is an exploded front isometric view of an airflow propulsion device according to an embodiment of the invention. In the embodiment shown in FIG. 3, the airflow propulsion device 200 includes a fan 210 housed between a forward housing 230 and a rear housing 260. The fan 210 is rotatably driven about a fan axis 218 by a motor 250 attached to the rear housing 260.

The forward housing 230 includes the entrance aperture 231 that receives the flow of air and particulates from the flow channel 112. The forward housing 230 further includes two exit apertures 232 (shown as a left exit aperture 232a and a right exit aperture 232b) that direct the flow radially outwardly after the flow of air and particulates has passed through the fan 210. The exit apertures 232 are defined by two wall portions 239, shown as a forward wall portion 239a in the forward housing 230 and a rear wall portion 239b in the rear housing 260. The forward and rear wall portions 239a, 239b together define the exit apertures 232 when the forward housing 230 is joined to the rear housing 260.

In one embodiment, the forward housing 230 includes a plurality of through-holes 233, each receiving a screw 264 which terminates in a corresponding receiving hole. In other embodiments, other devices can be used to secure the two housings 230, 260 including clips or flexible notches and slots. Housing gaskets 235 between the forward and rear housings 230, 260 seal the interface therebetween and prevent the flow from leaking from the housings as the flow passes through the fan 210.

The fan 210 includes a central hub 211 and a fan disk 212 extending radially outwardly from the hub 211. A plurality of spaced-apart vanes 213 are attached to the disk 212 and extend radially outwardly from the hub 211. In one embodiment, the vanes 213 are concave and bulge outwardly in a clockwise direction. Accordingly, when the fan 210 is rotated clockwise, the fan 210 draws the flow of air and particulates through the entrance aperture 231, pressurizes or imparts momentum to the flow, and directs the flow outwardly through the exit apertures 232.

Each vane 213 has an inner edge 214 near the hub 211, a first top edge 217, a second top edge 219 between inner edge 214 and first top edge 217 and an outer edge 215 spaced radially outwardly from inner edge 214. Adjacent vanes 213 are spaced apart from each other to define a channel 216 extending radially therebetween. In one embodiment, the flow area of each channel 216 remains approximately constant throughout the length of the channel. For example, in one embodiment, the width W of each channel 216 increases in the radial direction, while the height H of each channel decreases in the radial direction from an inner height (measured along the inner edge 214 of each vane 213) to a smaller outer height (measured along the outer edge 215 of each vane). In a further aspect of this embodiment, the sum of the flow areas of each channel 216 is approximately equal to the flow area of the entrance aperture 231. Accordingly, the flow area from the entrance aperture 231 through the channels 216 remains approximately constant and is matched to the flow area of the inlet aperture 111, discussed above with reference to FIG. 2.

The fan 210 is powered by the fan motor 250 to rotate in the clockwise direction. The fan motor 250 has a flange 255 attached to the rear housing 260 with bolts 254. The fan motor 250 further includes a shaft 251 that extends through a shaft aperture 261 in the rear housing 260 to engage the fan 210. A motor gasket 252 seals the interface between the rear housing 260 and the fan motor 250 to prevent the flow from escaping through the shaft aperture 261. One end of the shaft 251 is threaded to receive a nut 256 for securing the fan 210 to the shaft. When fully in place, nut 256 is located in recess 220. Locating nut 256 in recess 220 reduces the outward profile of hub 211 preventing debris from becoming lodged on fan 210.

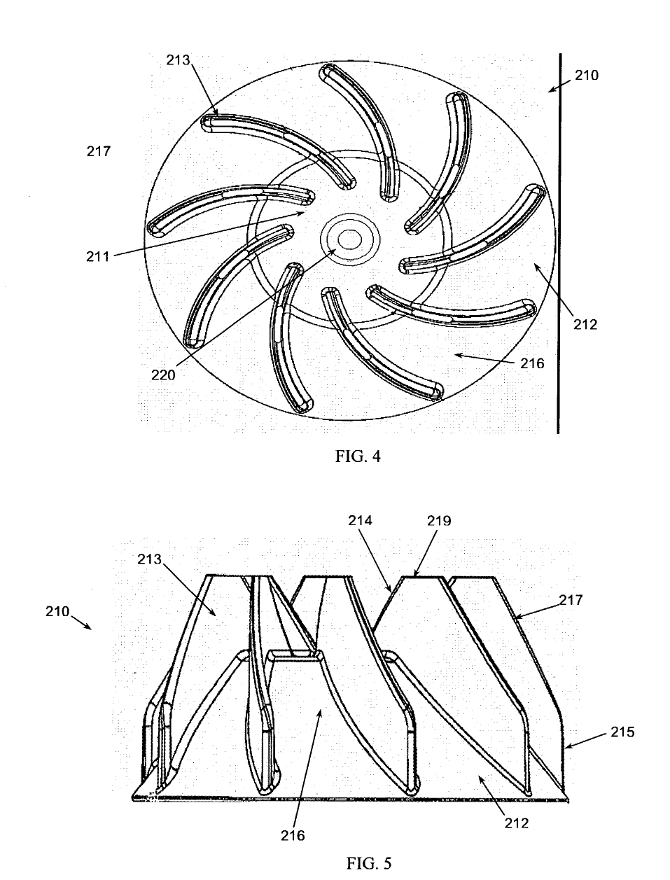

As shown in FIGS. 4 & 5, each vane 213 includes first top edge 217 extending axially away from hub 211 adjacent the inner edge 214 of the vane. In the embodiment shown in FIG. 5, first top edge 217 and inner edge 214 are connected by second top edge 219 that is perpendicular to the axis of rotation of fan 210.

In one embodiment, the fan 210 is sized to rotate at a relative slow rate while producing a relatively high flow rate. For example, the fan 210 can rotate at a rate of 7,700 rpm to move the flow at a peak rate of 132 cubic feet per minute (cfm). As the flow rate decreases, the rotation rate increases. For example, if the intake aperture 111 (FIG. 2) is obstructed, the same fan 210 rotates at about 8,000 rpm with a flow rate of about 107 cfm and rotates at about 10,000 rpm with a flow rate of about 26 cfm.

In other embodiments, the fan 210 can be selected to have different flow rates at selected rotation speeds. For example, the fan 210 can be sized and shaped to rotate at rates of between about 6,500 rpm and about 9,000 rpm and can be sized and shaped to move the flow at a peak rate of between about 110 cfm and about 150 cfm. In any case, by rotating the fan 210 at relatively slow rates while maintaining a high flow rate of air through the airflow propulsion device 200, the noise generated by the vacuum cleaner 10 can be reduced while maintaining a relatively high level of performance.

Returning now to FIG. 2, the flow exits the airflow propulsion device 200 through the exit apertures 232 in the form of two streams, each of which enters one of the conduits 30. In other embodiments, the airflow propulsion device can include more than two apertures 232, coupled to a corresponding number of conduits 30. An advantage of having a plurality of conduits 30 is that if one conduit 30 becomes occluded, for example, with particles or other matter ingested through the intake aperture 111, the remaining conduit(s) 30 can continue to transport the flow from the airflow propulsion device. Furthermore, if one of the two conduits 30 becomes occluded, the tone produced by the vacuum cleaner 10 (FIG. 1) can change more dramatically than would the tone of a single conduit vacuum cleaner having the single conduit partially occluded. Accordingly, the vacuum cleaner 10 can provide a more noticeable signal to the user that the flow path is obstructed or partially obstructed.

Each conduit 30 can include an elbow section 31 coupled at one end to the exit aperture 232 and coupled at the other end to an upwardly extending straight section 36. The combined flow area of the two exit apertures 232 is less than the flow area through the intake opening 111. Accordingly, the flow can accelerate and gain sufficient speed to overcome gravitational forces while traveling upwardly from the elbow sections 31 through the straight sections 36. In one aspect of this embodiment, the reduced flow area can remain approximately constant from the exit apertures 232 to the manifold 50 (FIG. 1).

Each elbow section 31 is sealed to the corresponding exit aperture 232 with an elbow seal 95. In one embodiment, the elbow sections 31 can rotate relative to the airflow propulsion device 200 while remaining sealed to the corresponding exit aperture 232. Accordingly, users can rotate the conduits 30 and the handle 45 (FIG. 1) to a comfortable operating position. In one aspect of this embodiment, at least one of the elbow sections 31 can include a downwardly extending tab 34. When the elbow section 31 is oriented generally vertically (as shown in FIG. 2), the tab 34 engages a tab stop 35 to lock the elbow section 31 in the vertical orientation. In one embodiment, the tab stop 35 can be formed from sheet metal, bent to form a slot for receiving the tab 34. The tab stop 35 can extend rearwardly from the baseplate 110 so that when the user wishes to pivot the elbow sections 31 relative to the intake body 100, the user can depress the tab stop 35 downwardly (for example, with the user's foot) to release the tab 34 and pivot the elbow sections 31.

In one embodiment, each elbow seal 95 can include two rings 91, shown as an inner ring 91a attached to the airflow propulsion device 200 and an outer ring 91b attached to the elbow section 31. The rings 91 can include a compressible material, such as felt, and each inner ring 91a can have a surface 92 facing a corresponding surface 92 of the adjacent outer ring 91b. The surfaces 92 can be coated with Mylar or another non-stick material that allows relative rotational motion between the elbow sections 31 and the airflow propulsion device 200 while maintaining the seal therebetween. In a further aspect of this embodiment, the non-stick material is seamless to reduce the likelihood for leaks between the rings 91. In another embodiment, the elbow seal 95 can include a single ring 91 attached to at most one of the airflow propulsion device 200 or the elbow section 31. In a further aspect of this embodiment, at least one surface of the ring 91 can be coated with the non-stick material to allow the ring to more easily rotate.

Each elbow section 31 can include a male flange 32 that fits within a corresponding female flange 240 of the airflow propulsion device 200, with the seal 95 positioned between the flanges 32, 240. Retaining cup portions 123, shown as a lower retaining cup portion 123a in the base plate 110 and an upper retaining cup portion 123b in the inner cover 150, receive the flanges 32, 240. The cup portions 123 have spaced apart walls 124, shown as an inner wall 124a that engages the female flange 240 and an outer wall 124b that engages the male flange 32. The walls 124a, 124b are close enough to each other that the flanges 32, 240 are snugly and sealably engaged with each other, while still permitting relative rotational motion of the male flanges 32 relative to the female flanges 240.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. An airflow propulsion device for moving a flow of air and particulates through a vacuum cleaner having a central hub with a hub axis and a plurality of vanes depending from the hub and extending in an approximately radial direction away from the hub axis, said vanes comprising:
an inner edge located near the central hub;
an outer edge spaced radially outward from the inner edge;
a first top edge;
a second top edge located between the inner edge and the first top edge, and
wherein the second top edge is orientated in a direction less than parallel to the hub axis.

2. The airflow propulsion device of claim2 further comprising:
a motor;
a coupling device for coupling the motor to the hub; and
a recess located in the hub for allowing the coupling device to reside within the hub.

3. The airflow propulsion device of claim 3 wherein the coupling device is a nut.

4. The airflow propulsion device of claim 2 wherein the second top edge is orientated perpendicular to the hub axis.

5. The airflow propulsion device of claim 2 further comprising a housing disposed about the vanes, the housing having an intake opening and a channel extending circumferentially around the intake opening, the channel being sized to receive the projections of the vanes while the vanes rotate about the hub axis.

6. A method for moving a flow of air and particulates through a propulsion device, comprising:
directing the flow of air and particulates toward a hub having a hub axis and a plurality of vanes extending outwardly from the hub axis; and
imparting momentum to the flow of air and particulates by passing the flow between the rotating vanes;
wherein the plurality of vanes comprise,
an inner edge located near the central hub;
an outer edge spaced radially outward from the inner edge;
a first top edge;
a second top edge located between the inner edge and the first top edge, and
wherein the second top edge is orientated in a direction less than parallel to the hub axis.

7. The method of claim 6 wherein the propulsion device further comprises:
a motor;
a coupling device for coupling the motor to the hub; and
a recess located in the hub for allowing the coupling device to reside within the hub.

8. The method of claim 7 wherein the coupling device is a nut.

9. The method of claim 6 wherein the second top edge is orientated perpendicular to the hub axis.

10. The method of claim 6 wherein the propulsion device further comprises a housing disposed about the vanes, the housing having an intake opening and a channel extending circumferentially around the intake opening, the channel being sized to receive the edges of the vanes while the vanes rotate about the hub axis.
